(19) United States
(12) Patent Application Publication
(10) Pub. No.: US 2022/0058230 A1
(43) Pub. Date: Feb. 24, 2022

(54) 3D SEARCH ENGINE

(71) Applicant: Marwan Hassan, Fremont, CA (US)

(72) Inventor: Marwan Hassan, Fremont, CA (US)

(73) Assignee: Marwan Hassan, Fremont, CA (US)

(21) Appl. No.: 16/873,943

(22) Filed: Aug. 19, 2020

(51) Int. Cl. G06F 16/9535; G06F 16/951; G06F 16/51; G06F 16/532; G06F 16/9538; G06K 9/62; G06K 9/00

(52) U.S. Cl. CPC G06F 16/9535; G06F 16/951; G06F 16/51; G06K 9/00208; G06F 16/9538; G06K 9/6215; G06K 9/00214; G06F 16/532

(57) ABSTRACT

The present invention discloses a 3D web search engine for crawling, indexing, and searching through 3D models located on the World Wide Web. The user provides a search query in the form of a 3D model to reach for web pages that contain similar 3D models. The search query can be in the form of a 3D model, an image of a 3D model, or a drawing of a 3D model. The user has different options to filter the 3D models of the search results according to their needs or preference.

### CROSS-REFERENCE TO RELATED APPLICATION

This application claims the benefits of a U.S. Provisional Patent Application No. 62/922,686, filed Aug. 22, 2019.

### BACKGROUND

Web search engines usually serve the search of text, images, or videos. With the spread of 3D scanning devices, depth sensing cameras, and 3D modeling software applications, a huge number of 3D model files are created on the World Wide Web. Until now, there has been no universal search engine that provides Web crawling, indexing, and searching for 3D models or files.

As known in the art, a search engine is a software system that is designed to search for information on the World Wide Web. The search results are generally presented in a line of results often referred to as search engine results or pages. The information may be a mix of web pages, images, videos, and other types of files. Some search engines mine data available in databases or open directories. Unlike web directories, which are maintained only by human editors, search engines also maintain real-time information by running an algorithm on a web crawler.

A traditional search engine maintains Web crawling, indexing, and searching. A Web crawler, sometimes called a spider, is an Internet bot that systematically browses the World Wide Web, typically before the Web indexing. Web search engines use Web crawling or spidering software to update their web content or indices of other sites' web content. Web crawlers can copy all the pages they visit for later processing by a search engine, which indexes the downloaded pages so the users can search much more efficiently.

Traditional search engine indexing collects, parses, and stores data to facilitate fast and accurate information retrieval. Index design incorporates interdisciplinary concepts from linguistics, cognitive psychology, mathematics, informatics, and computer science. Popular engines focus on the full-text indexing of online, natural language documents. Media types such as video, audio and graphics are also searchable. Meta search engines reuse the indices of other services and do not store a local index, whereas cache-based search engines permanently store the index along with the corpus. Unlike full-text indices, partial-text services restrict the depth indexed to reduce index size. Larger services typically perform indexing at a predetermined time interval due to the required time and processing costs, while agent-based search engines index in real time.

The purpose of storing an index is to optimize speed and performance in finding relevant documents for a search query. Without an index, the search engine would scan every document in the corpus, which would require considerable time and computing power. For example, while an index of 10,000 documents can be queried within milliseconds, a sequential scan of every word in 10,000 large documents could take hours. The additional computer storage required to store the index, as well as the considerable increase in the time required for an update to take place, are traded off for the time saved during information retrieval.

A traditional web search is a query that a user enters into a web search engine to satisfy his or her information needs. Web search queries are distinctive in that they are often plain text or hypertext with optional search-directives (such as “and”/“or” with “−” to exclude). They vary greatly from standard query languages, which are governed by strict syntax rules as command languages with keyword or positional parameters.

### SUMMARY

The present invention discloses a 3D search engine that provides online crawling, indexing, and searching for 3D models. In one embodiment of the present invention, the crawling is an Internet bot that browses the World Wide Web for 3D models. This is done to update the content of the 3D search engine for later processing of indexing and searching. The crawling of the present 3D search engine copies or downloads available online 3D model files for later processing by the 3D search engine. This is to index the downloaded files or models so the users can search much more efficiently.

The indexing of the present 3D search engine includes analyzing and storing the crawled 3D models in certain formats to facilitate the 3D models retrieval during the search process. In one embodiment, the analyzing of the present invention associates each 3D model with a plurality of two-dimensional drawings representing the 3D model. The purpose of storing the indexing is to optimize speed and performance in finding relevant 3D models during the search process.

The web searching of the present invention is a query that a user enters into the 3D search engine to satisfy thier search needs. The search query of the user can be in the form of a 3D model, picture of a 3D model or 3D object, or drawing representing a 3D model. In one embodiment of the present invention, the search query includes optional search-directives (such as “and”/“or” with “−” to exclude). This is to provide the user with more control of the search results of the 3D models.

In one embodiment, the search results of the present invention are presented in a line of results referred to as search engine results pages, which s similar to available online search engines such as GOOGLE or BING. These search engine results pages contain similar 3D models of the search query. Selecting or clicking any of the search results leads to the opening of the page or website that contains the similar 3D model/s. In another embodiment, the user can filter the search results according to the 3D model type such as wireframe, surface or solid models. In addition, the user can filter the search results according to the file extension of the 3D model such as 3DS, FBX, DAE, STP or the like. In yet another embodiment, the user can filter the search results according to location, size, color or texture of the 3D model.

### BRIEF DESCRIPTION OF DRAWINGS

FIG. 1 illustrates a 3D model of a car.

FIG. 2 illustrates a virtual container surrounding the 3D model of the car.

FIGS. 3 to 5 illustrate slicing the 3D model of the car with three groups of cross-sections parallel to the xy, xz, and yz-planes.

FIG. 6 illustrates an example of a drawing stored in a database to represent a cross-section for the 3D model of the car.

FIG. 7 illustrates another car with a cross-section to generate a drawing similar to the drawing stored in the database.

FIGS. 8 to 10 illustrate drawings of parts of a car that partially matche the drawing stored in the database.

FIG. 11 illustrates a drawing of a car stored in a database, and partially matches the previous three drawings.

FIG. 12 illustrates a drawing of a 3D model of a vehicle that is different from the previous car.

FIGS. 13 and 14 illustrate a 3D model of a bird and a drawing representing the 3D model of the bird.

FIGS. 15 and 16 illustrate a 3D model of a horse and a drawing representing the 3D model of the horse.

FIGS. 17 and 18 illustrate a 3D model of a human's body and a drawing representing the 3D model of the human's body.

FIGS. 19 and 20 illustrate a 3D model of a home and a drawing representing the 3D model of the home.

FIGS. 21 to 22 illustrate a 3D model of a boat and a drawing representing the 3D model of the boat.

FIGS. 23 and 24 illustrate two drawings representing two 3D models of a banana and an apple.

FIG. 25 illustrates a drawing representing a 3D model of an animal.

FIGS. 26 and 27 illustrate a 3D model of a human's head and a drawing representing the 3D model of the human's head.

FIG. 28 illustrates a 3D model of three walls and a door located on one of the three walls.

FIG. 29 illustrates a cross-section of the three walls and the door.

FIGS. 30 and 31 illustrate a 3D model of a table and a drawing representing the 3D model of the table.

FIG. 32 illustrates slicing a 3D model with a plurality of cross-sections parallel to the xy, xz, and yz-planes.

FIGS. 33 to 38 illustrate using a combination of two drawings to search for 3D models that have a common cross-section.

FIG. 39 illustrates an example of a 3D web search engine, using the present invention, to search the World Wide Web for 3D models.

### DETAILED DESCRIPTION

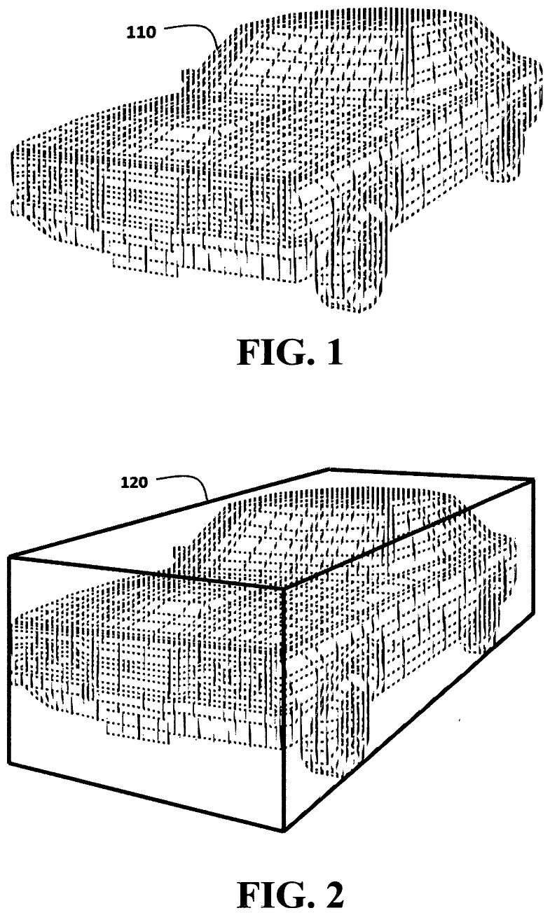

FIG. 1 illustrates a 3D model 110 of a first car in the form of a 3D point cloud. The 3D model was created by a 3D scanner using a depth sensing camera that detects the distances between the external surface points of the scanned object and the position of the depth sensing camera. FIG. 2 illustrates a virtual 3D container 120 that surrounds the 3D model of the scanned car.

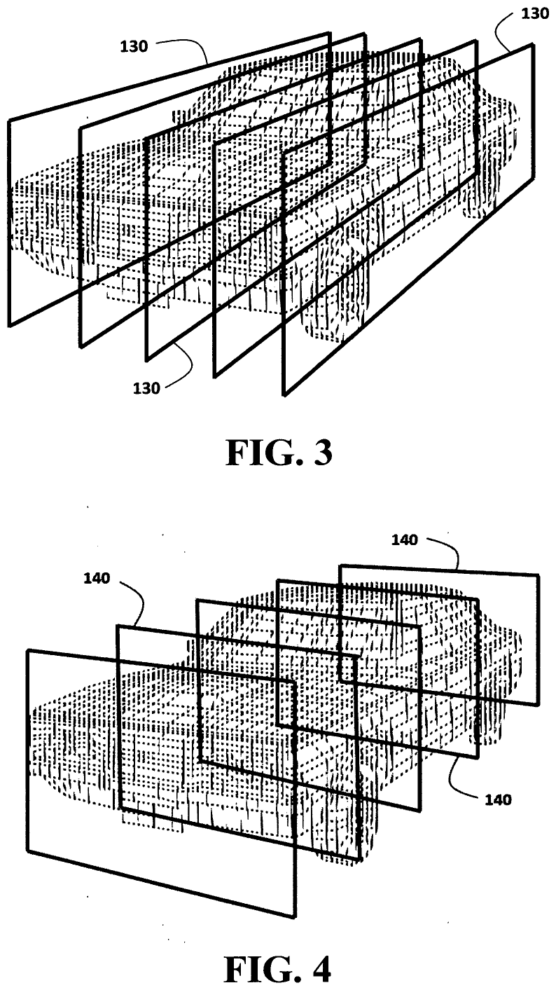

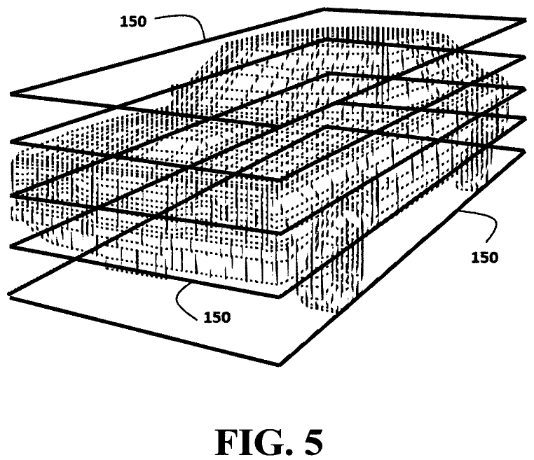

FIG. 3 illustrates slicing the 3D model with a first group of cross-sections 130 parallel to the xz-plane. FIG. 4 illustrates slicing the 3D model with a second group of cross-sections 140 parallel to the yz-plane. FIG. 5 illustrates slicing the 3D model with a third group of cross-sections 150 parallel to the xy-plane. As shown in the drawings, the slices of the first, second and third groups of cross-sections are located inside the virtual 3D container.

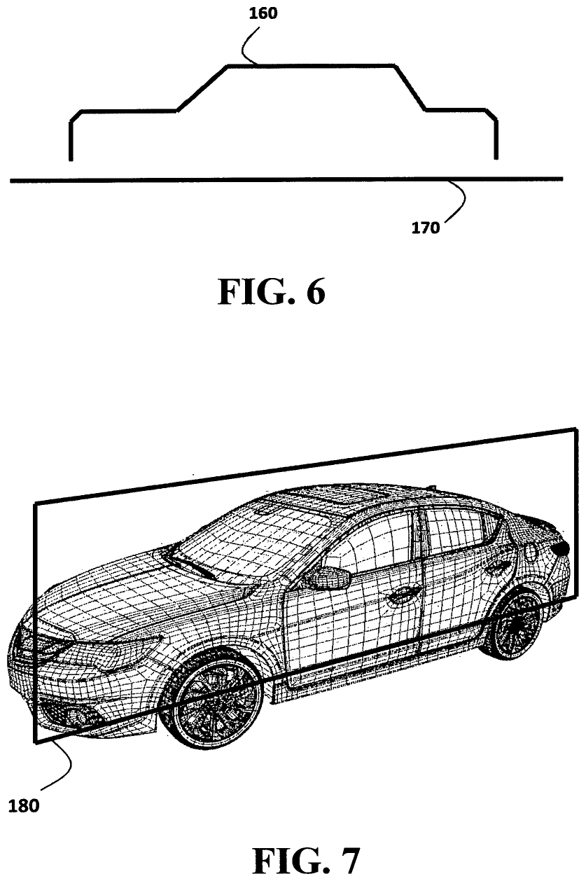

Each plurality of points located in a cross section of the first, second and third groups is converted into lines corresponding to the shape of the cross-section points. FIG. 6 illustrates a drawing representing the outlines of the first car 160 and the ground 170 beneath the first car according to one cross-section parallel to the xz-plane. Such a drawing is stored in a database that associates each drawing of a cross-section of the first car with the URL of the page where the 3D model of the first car is located on the World Wide Web.

The database of the drawings enables locating the 3D models on the World Wide Web when similar 3D models are provided to the present 3D search engine. For example, FIG. 7 illustrates a 3D model of a second car sliced with a cross-section 180. The drawing created from the cross-section of the second car is similar to the cross-section drawing of FIG. 6 of the first car.

That means checking the database against the second car drawings leads to the URL of the first car model on the World Wide Web. This is achieved by automating the slicing of the cross-sections of the second car model to automatically create its drawings. In other words, if a user is searching the World Wide Web for 3D models similar to the 3D model of the second car then they can reach the URL of the first car model. If the database includes multiple URLs of multiple 3D models with similar drawings then the user can reach all these multiple URLs in their search.

According to the previous description, in one embodiment, the present invention allows for the comparison of a complete 3D model to another complete 3D model by associating them to each other if they have a common cross-section. In another embodiment, the present invention allows for the comparison of a part of a 3D model to a complete 3D model by associating them to each other if they have a common part of a cross-section.

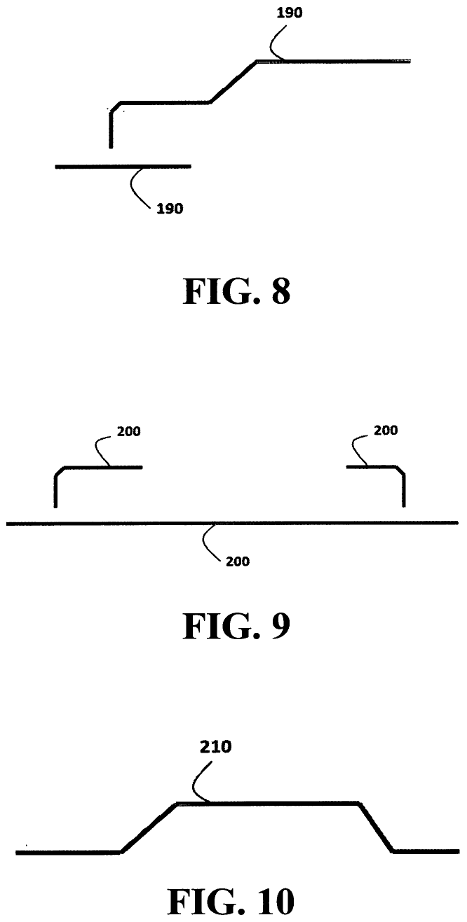

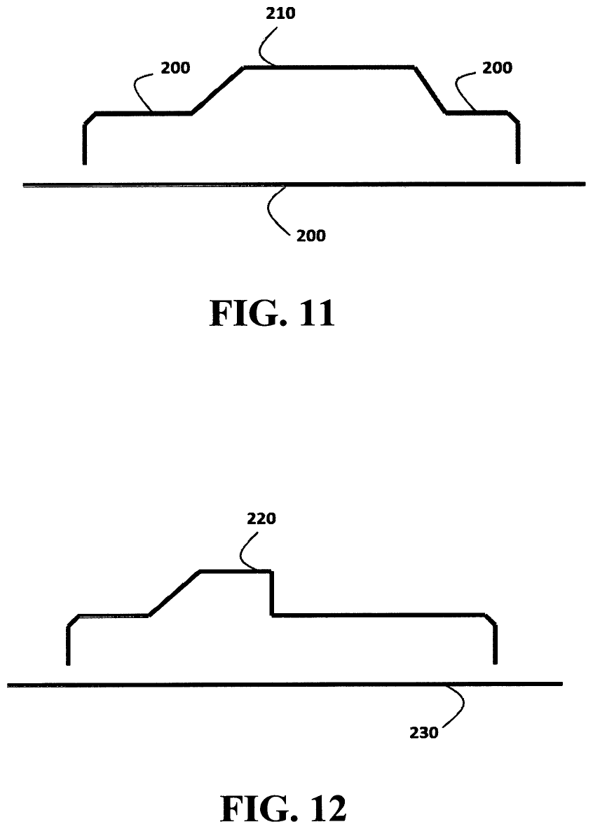

For example, each of FIGS. 8 to 10 illustrate a drawing generated of a cross-section from a partial 3D model of a car. FIG. 11 illustrates a drawing generated and stored in a database using a cross-section of a complete 3D model of a car. Comparing the drawings of FIGS. 8 to 10 against the drawings of the database confirms that the drawings of FIGS. 8 to 10 represent parts of the complete 3D model of the car. Such search capability of the present invention allows searching for 3D models using partial 3D models as a search query.

Using a partial 3D model in the search may require providing multiple partial 3D models to get accurate results. For example, FIG. 12 illustrates a drawing stored in a database and generated of a cross-section of a complete 3D model of a vehicle. Comparing the drawings of FIGS. 8 to 10 with the drawing of FIG. 12 confirms that drawing of FIG. 10 does not belong to the complete 3D model of the vehicle. If the drawings of FIGS. 8 to 10 are provided together as a search query the search result will include FIG. 11 and exclude FIG. 12.

In such a case, if a user successively provides a search query using the three drawings of FIGS. 8 to 10 by typing the “and” command then the search result will only include the 3D model of FIG. 11. If a user successively provides a search query using the three drawings of FIGS. 8 to 10 by typing the “or” command then the search result will include the 3D models of FIGS. 11 and 12. The user can also mix the two commands of “and” and “or” for the same search query to get different search results. For example, FIG. 8 “and” FIG. 9 “or” FIG. 10 will provide different search results other than FIG. 8 “or” FIG. 9 “and” FIG. 10.

Generally, the search query of the present invention includes such optional search-directives to provide the user with more control of the search results. This is similar to the optional search-directives of traditional web search engines such as GOOGLE or BING. Moreover, most search features that are available in traditional web search engines are utilized in the 3D search engine of the present invention.

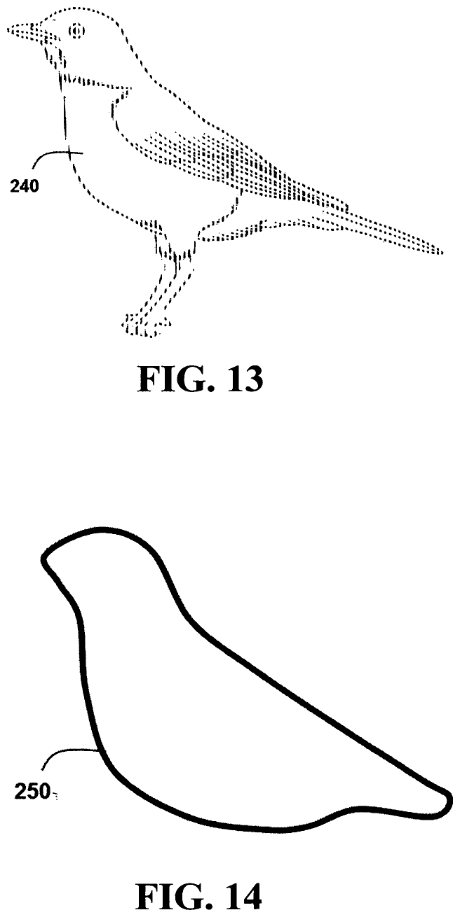

Overall, the search of the present invention on the World Wide Web is not limited to certain shapes or types of 3D models. For example, FIG. 13 illustrates a 3D model 240 of a bird, and FIG. 14 illustrates a drawing 250 stored in the database to represent this 3D model in the search process. Although the cross-sections of the 3D model of the bird create multiple drawings, the drawing of FIG. 14 is the best one to retrieve the search results. The drawing is useful to indicate that the 3D model is for a bird, but it is not enough to differentiate the kind of bird. In this case, other cross-sections, especially for the bird's head, can help identifying the bird kind.

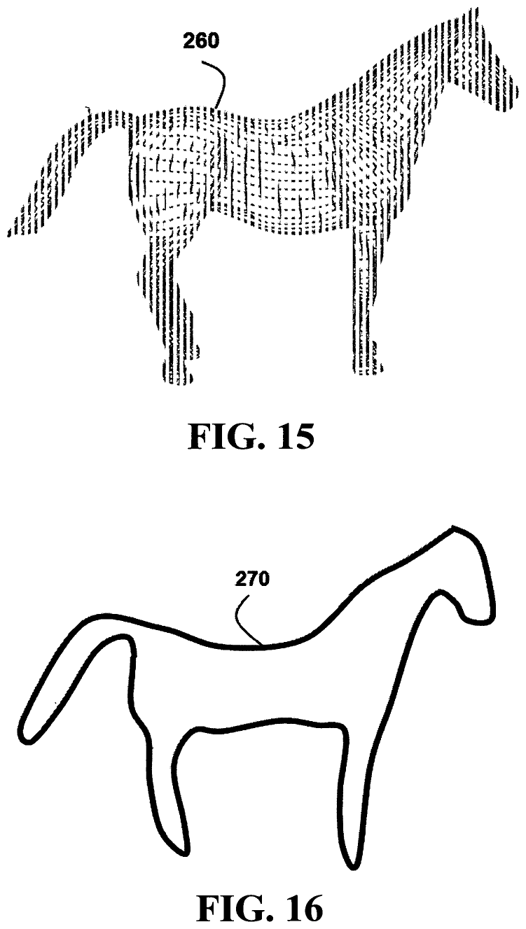

FIG. 15 illustrates a 3D model 260 of a horse, and FIG. 16 illustrates a drawing 270 stored in the database to represent this 3D model in the search process. The drawing may look similar to some other animals, so in this case, additional cross-sections, especially for the horse's head, can help in differentiating the horse from the other animals.

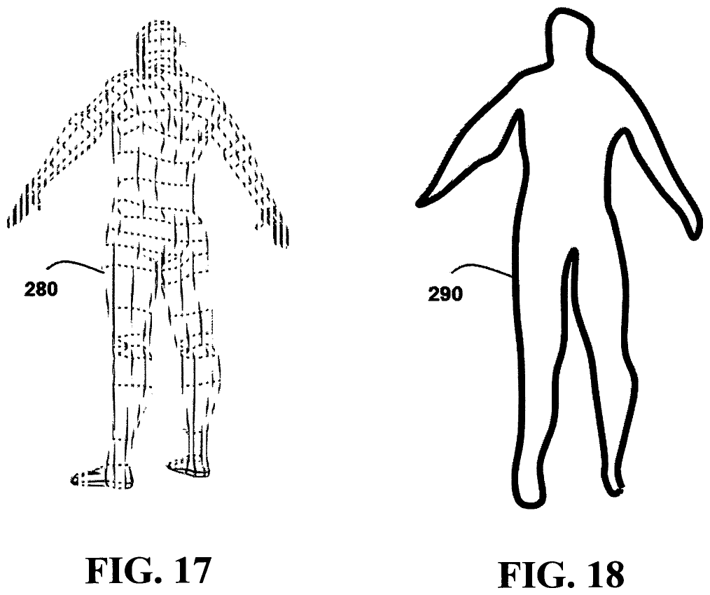

FIG. 17 illustrates a 3D model 280 of a human's body, and FIG. 18 illustrates a drawing 290 stored in the database to represent this 3D model in the search process. The drawing is useful to indicate that the 3D model is for a human, but it is not enough to indicate the identity of the human. In this case, additional cross-sections, especially for the human's head, can help in identifying the identity of the human when compared with other cross-sections of other 3D models of humans.

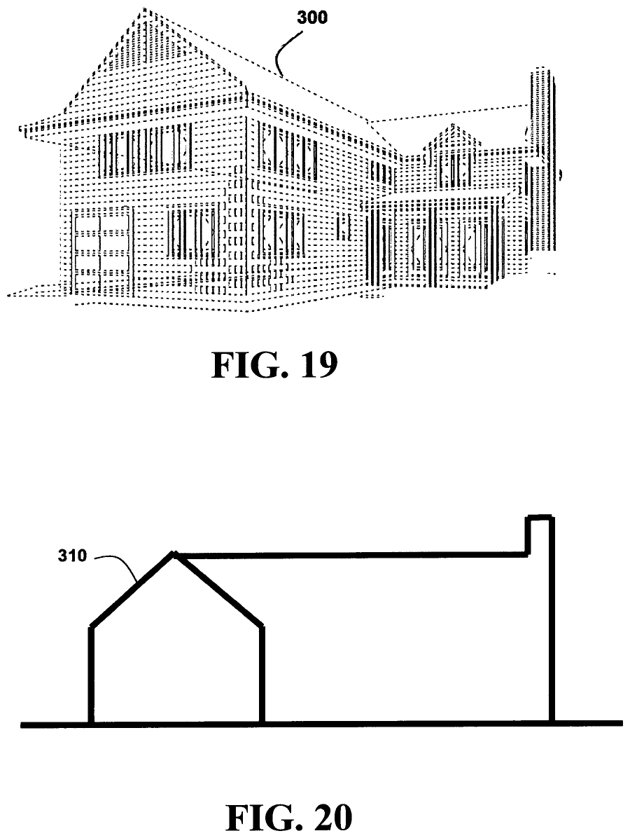

FIG. 19 illustrates a 3D model 300 of a home, and FIG. 20 illustrates a drawing 310 stored in the database to represent this 3D model in the search process. As shown, the drawing of FIG. 20 can represent many other homes, but to search for this exact home of FIG. 19, multiple cross-sections of this 3D model need to be used. The multiple cross-sections of the 3D model of the home specifies more details about the location of the home walls, doors, windows, and chimney, in addition to the roof shape. Such data can easily differentiate a home from another in the search process of the present invention.

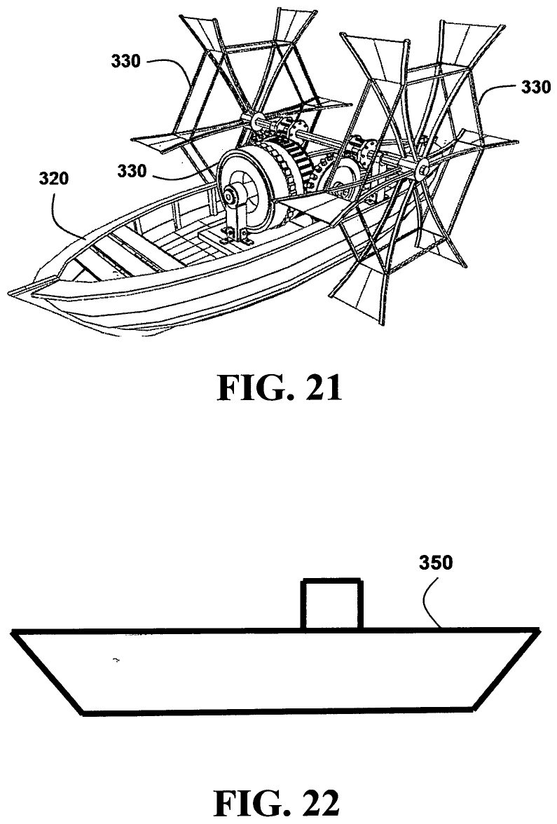

FIG. 21 illustrates a detailed 3D model of a boat 320 with some various components 330. FIG. 22 illustrates a drawing 310 stored in the database to represent this 3D model in the search process of the present invention. The components 330 included in this 3D model do not appear in the drawing of the FIG. 22, but the multiple cross-sections used in slicing this 3D model generate various drawings that can represent all the details of the various components. This helps in differentiating this exact 3D model of a boat from other 3D models of other boats.

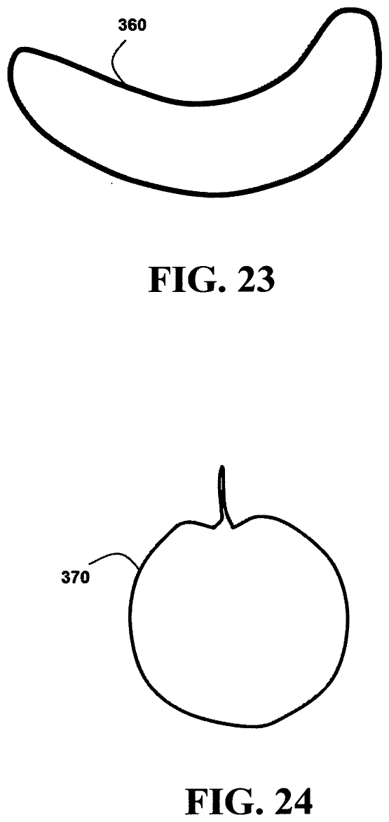

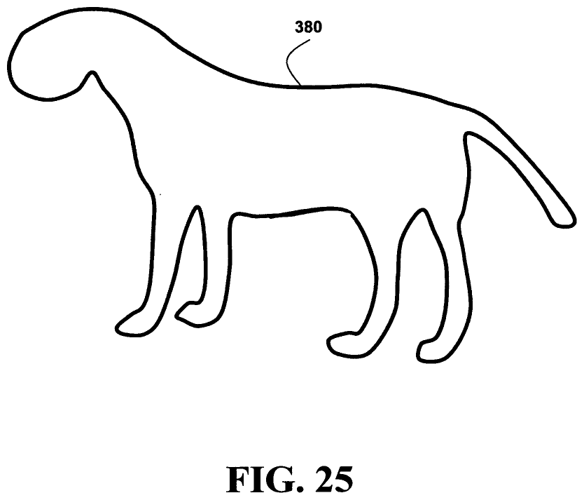

FIG. 23 illustrates a drawing 360 stored in a database to represent a banana in the search process of the present invention. FIG. 24 illustrates a drawing 370 stored in a database to represent an orange in the search process of the present invention. FIG. 25 illustrates a drawing 380 stored in a database to represent an animal in the search process of the present invention. As mentioned previously, these single drawings are examples of various drawings that can be generated using cross-sections. The higher the number of stored drawings there are the more accurate the search results will be.

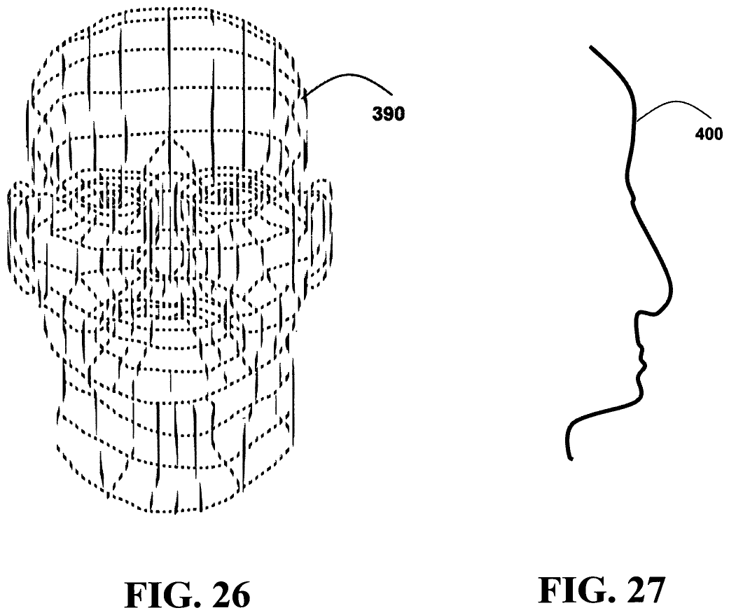

FIG. 26 illustrates a 3D model of a human's head 390. FIG. 27 illustrates a drawing 400 stored in a database to represent this human's head in the search process. As shown in the drawing, the exact details of the face, nose and chin are presented. This allows for reaching accurate search results that differentiate between different 3D models of different humans.

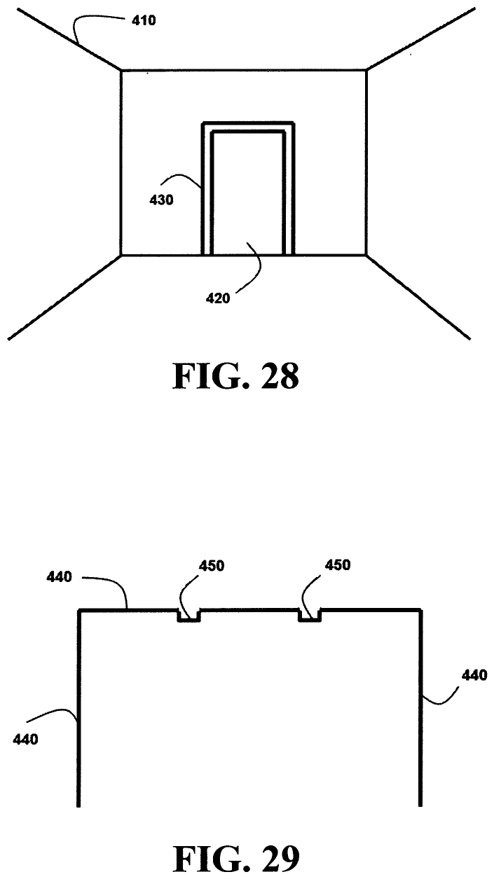

FIG. 28 illustrates a 3D model of three walls 410 and a door 420 located on one of the three walls. FIG. 29 illustrates a drawing representing a floor plan or a cross-section of the 3D model. As shown, the three walls 440 and the doorframe 450 are represented on the drawing. Using such a cross-section, the present invention is able to retrieve search results that exactly match the location of the door on its wall. If the user does not require such accuracy in the search results, they can ask for other 3D models that are not very similar.

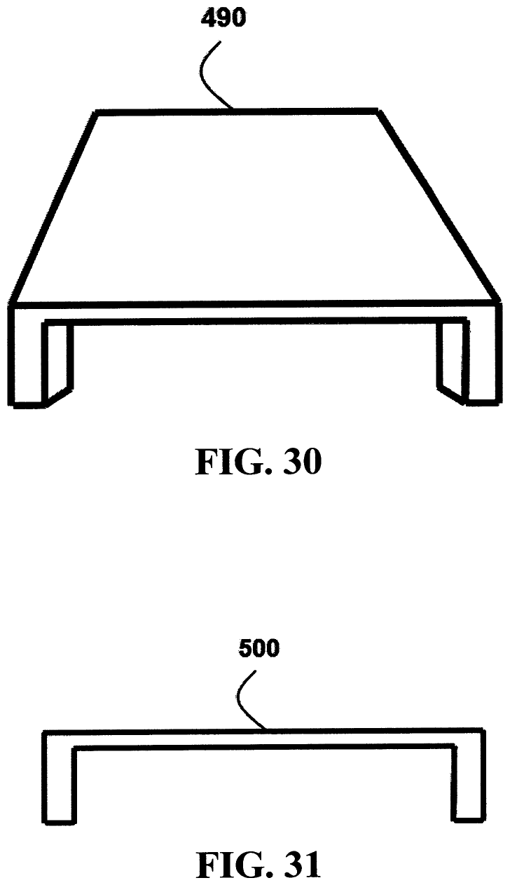

FIG. 30 illustrates a 3D model of a table, and FIG. 31 illustrates a drawing representing a cross-section of the 3D model of the table. As shown in the drawing, the table surface and legs are flat, which makes the present search provide search results of similar tables of flat surfaces and legs. In other words, the search results will exclude the tables of non-flat surface or legs. If the user does not require such accuracy in the search results, they can ask for other tables that are not very similar.

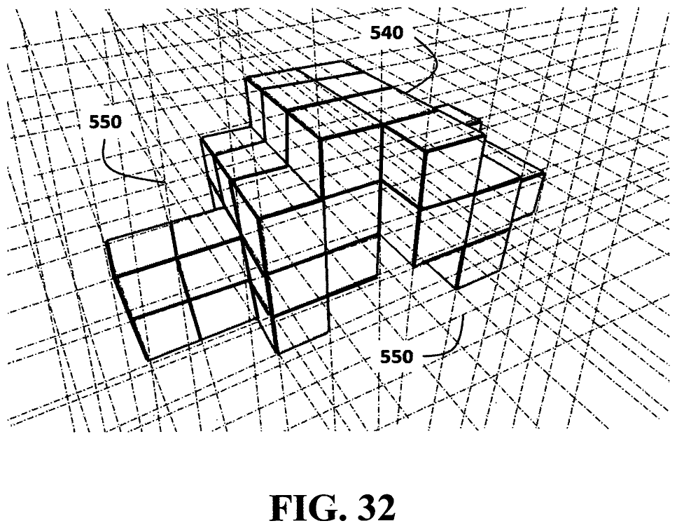

FIG. 32 illustrates the concept of the present invention of slicing the 3D model with a plurality of cross-sections parallel to the xy, xz, and yz-planes. As shown in the drawing, a 3D model 540 was sliced with cross-sections 550 parallel to the xy, xz, and yz-planes to generate a plurality of drawings representing the shape of the 3D model. Accordingly, the entire details of this complex 3D model can be represented by a plurality of drawings that facilitates the search results.

Generally, the slicing process of the present invention is done on two stages. The first stage is done during the crawling, where the 3D models of the World Wide Web are downloaded and sliced to be stored in a database. Each group of cross-section related to a 3D model are associated with the URL of the webpage where the 3D model is located on the Internet. The second stage is done when the user provides the search engine with a 3D model to search for its similar 3D models. At this stage, the 3D model provided by the user is sliced into cross-sections to be used during the search process. Checking the cross-sections of the provided 3D model against the cross-sections of the database allows reaching similar 3D models and accordingly allows reaching the URLs of these similar 3D models.

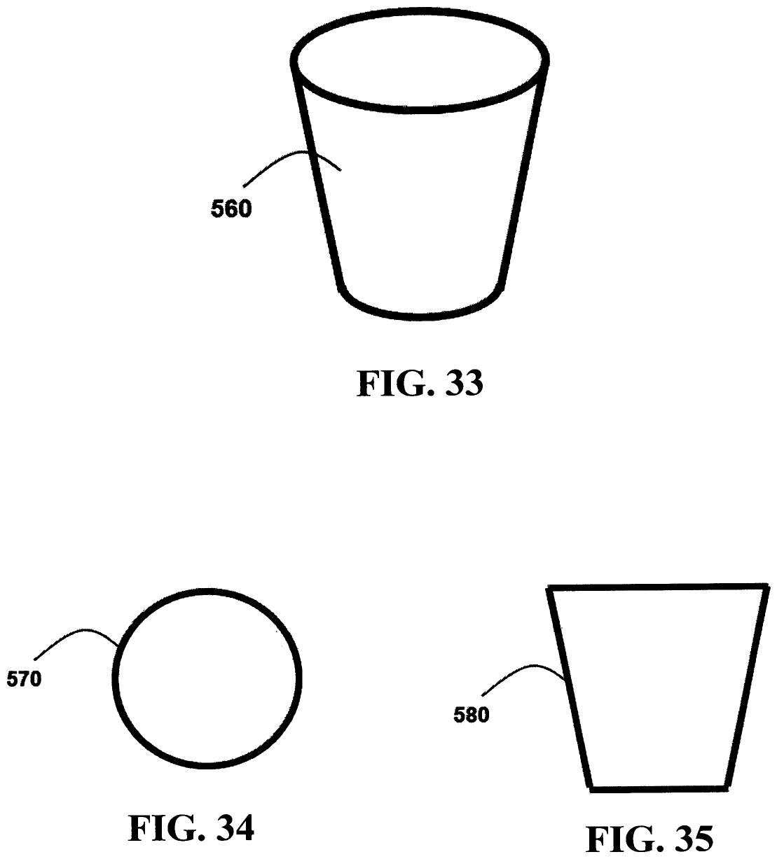

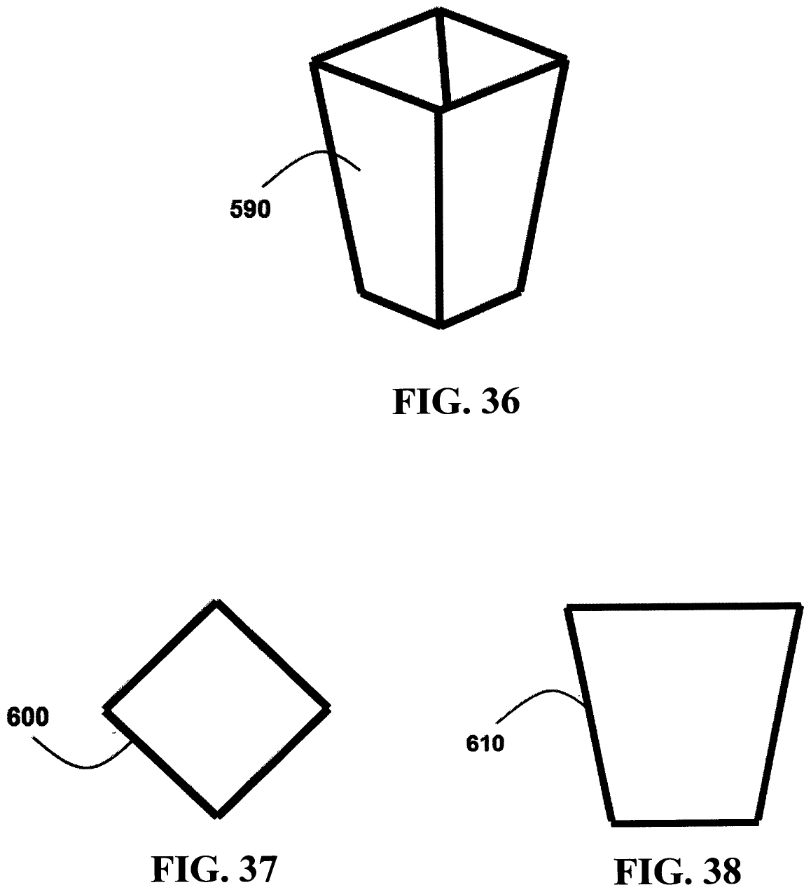

The importance of slicing the 3D model with multiple cross-sections is to generate multiple drawings representing the 3D model. Using a single drawing or single cross-section during the search process is not enough to obtain accurate search results. For example, FIG. 33 illustrates a 3D model of a first object 560 while FIG. 34 illustrates a first cross-section 570, and FIG. 35 illustrates a second cross-section 580 of this first object. FIG. 36 illustrates a 3D model of a second object 590 while FIG. 37 illustrates a first cross-section 600, and FIG. 38 illustrates a second cross-section 610 of this second object.

As shown in the drawings, the second cross-section of the first object, and the second cross-section of the second object look similar. Accordingly, if only such a single second cross-section is used during the search process, the 3D models of FIG. 33 and FIG. 36 will appear in the search results. If two cross-sections are used during the search process, such as the first and second cross-sections of the 3D model of FIG. 33 or FIG. 36, the search results will only show the exact 3D model of FIG. 33 or FIG. 36.

According to the previous descriptions and drawings, the present invention discloses a 3D search engine that provides online crawling, indexing, and searching for 3D models. In one embodiment of the present invention, the crawling is an Internet bot that browses the World Wide Web for 3D models. This is done to update the content of the 3D search engine for later processing of indexing and searching. The crawling of the present 3D search engine copies or downloads all available online 3D model files for later processing by the 3D search engine. This is done to index the downloaded files or models so that the users can search much more efficiently.

The indexing of the present 3D search engine includes analyzing and storing the crawled 3D models in certain formats to facilitate the 3D models retrieval during the search process. In one embodiment, the analyzing of the present invention associates each 3D model with a plurality of two-dimensional drawings representing the cross-sections of the 3D model. The purpose of storing or indexing is to optimize the speed and performance in finding relevant 3D models during the search process.

The web search of the present invention is a query that a user enters into the 3D search engine to satisfy their search needs. The search query of the user can be in the form of a 3D model. This 3D model is sliced with a plurality of cross-sections to generate multiple drawings to be used in the search process. Comparing the drawings of the 3D model provided by the user with the drawings stored in the database allows for the retrieval of search results of 3D models that are similar to the 3D model provided by the user. In one embodiment of the present invention, the search query includes optional search-directives (such as “and”/“or” with “-” to exclude). This is to provide the user with more control over the search results.

In one embodiment, the search results of the present invention are presented in a line of results referred to as search engine results pages, which is similar to available online search engines such as GOOGLE or BING. These search engine result pages contain similar 3D models of the search query. Selecting or clicking any of the search result pages leads to the opening of the page or website that contains similar 3D model/s on the computer display.

In another embodiment, the user can filter the search results according to the 3D model type such as wireframe, surface or solid models. Also, the user can filter the search results according to the file extension of the 3D model such as 3DS, FBX, DAE, STP or the like. In yet another embodiment, the user can filter the search results according to the location, size, color or texture of the 3D model.

According to the previous description, the user provides the search engine with a 3D model to be used as a search entry for the search process. Such a search entry can be in different formats other than a 3D model. For example, in one embodiment of the present invention, the search entry can be a picture of a 3D object or a picture of a 3D model. In this case, the present invention converts the picture into a drawing using an edge detection technique, as known in the art. Accordingly, the drawing is used as a search entry similar to the drawings generated by the cross-sections.

In another embodiment of the present invention, the user can draw on the computer display to represent a 3D model. The user's drawing is used as a search entry similar to the drawings generated by the cross-sections. In this case, the present invention provides the user with a virtual drawing tool to draw their drawings or freehand sketches similar to commercially available drawing software applications.

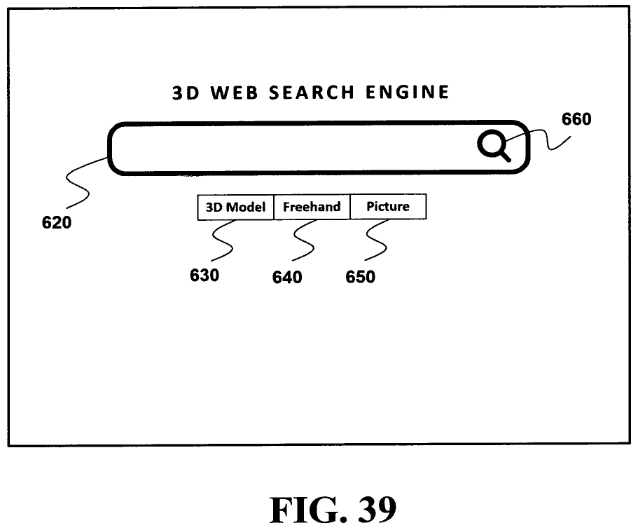

According to one embodiment of the present invention, FIG. 39 illustrates a UI of the present 3D web search engine, The search box 620 of the UI provides the user with three options of search entry which are a 3D model option 630, a drawing option 640, or a picture option 650. Once the user provides a 3D model, a drawing of a 3D model, or a picture of a 3D model and clicks the search button 660, then the search results in the form of URLs are displayed on the computer display. Clicking any of the URLs opens a webpage that contains a similar 3D model to the 3D model provided by the user as a search query.

1. A search method comprising:
crawling the World Wide Web to copy files representing 3D models;
indexing the 3D models in a database by representing each of the 3D models with a plurality of cross-sections associated with the webpages of the 3D models; and
searching the database by providing one or more cross-sections of a search 3D model to check the one more cross-sections against the plurality of cross-sections; and
presenting the webpages associated with the plurality of cross-sections that match the one or more cross-sections.

2. The search method of claim 1 wherein the World Wide Web is a database available on a source other than the World Wide Web.

3. The search method of claim 1 wherein the 3D models are in the form of wireframe models, surface models, solid models or point cloud models.

4. The search method of claim 1 wherein the files of the 3D models have different file extensions.

5. The search method of claim 1 wherein the plurality of cross-sections and the one or more cross-sections are automatically generated by a software program.

6. The search method of claim 1 wherein the plurality of cross-sections and the one or more cross-sections are parallel to the xy, xz, and/or yz-planes.

7. The search method of claim 1 wherein the webpages are in the form of URLs or Web addresses that specifies the location of the 3D models.

8. The search method of claim 1 wherein the one or more cross-sections is a drawing or freehand sketch representing the search 3D model.

9. The search method of claim 1 wherein the one or more cross-sections is an image of the search 3D model.

10. The search method of claim 1 wherein the searching includes optional search-directives of the web search query.

11. The search method of claim 1 whereas the user can filter the webpages according to the visual characteristics of the 3D models.

12. A search method comprising:
creating a database of multiple groups of cross-sections each of which represent a 3D model;
searching the database by providing a search cross-section of a search 3D model to locate the 3D model associated with a group of cross-sections that match the search cross-section;
presenting the search results in a form of a hyperlink that displays the 3D model on a computer display when a user clicks the hyperlink.

13. The search method of claim 12 wherein the multiple groups of cross-sections and the search cross-section are automatically generated by a software program.

14. The search method of claim 12 wherein the search cross-section is a drawing or a freehand sketch representing the search 3D model.

15. The search method of claim 12 wherein the search cross-section is an image of the search 3D model.

16. A search method to compare a search 3D model against a stored 3D models wherein the method comprising:
slicing the stored 3D models with a first plurality of cross-sections;
slicing the search 3D model with a second plurality of cross-sections; and
checking the first plurality of cross-sections against the second plurality of the cross-sections to retrieve the stored 3D models that have cross-sections similar to the cross-sections of the search 3D model.

17. The search method of claim 16 wherein the first and second plurality of cross-sections are automatically generated by a software program.

18. The search method of claim 16 wherein the first and second plurality of cross-sections are parallel to the xy, xz, and/or yz-planes.

19. The search method of claim 16 wherein the slicing of the search 3D model is a drawing or a freehand sketch representing the search 3D model.

20. The search method of claim 16 wherein the slicing of the search 3D model is an image of the search 3D model.
